(19) United States
(12) Patent Application Publication
(10) Pub. No.: US 2026/0367918 A1
(43) Pub. Date: Nov. 19, 2026

(54) SUB-REGISTER INSTRUCTIONS, CHECKSUM INSTRUCTIONS, AND PROGRAMMABLE CONTENT-ADDRESSABLE MEMORIES

(71) Applicant: Tom Herbert, Los Gatos, CA (US)

(72) Inventor: Tom Herbert, Los Gatos, CA (US)

(21) Appl. No.: 19/748,065

(22) Filed: Jul. 20, 2026

Related U.S. Application Data
(63) Continuation-in-part of application No. 19/379,671, filed on Nov. 4, 2025, now Pat. No. 12,688,008.
Application No. 19/379,671 is a continuation-in-part of application No. 18/762,396, filed on Jul. 2, 2024, now Pat. No. 12,461,885.
Application No. 18/762,396 is a continuation-in-part of application No. 17/233,149, filed on Apr. 16, 2021, now Pat. No. 12,026,546.
(60) Provisional application No. 63/011,002, filed on Apr. 16, 2020.

(51) Int. Cl. G06F 9/30

(52) U.S. Cl. CPC G06F 9/3016; G06F 9/30109

(57) ABSTRACT

A processor architecture provides sub-register instructions that operate on contiguous ranges of bits within integer registers to accelerate workloads where data is packed densely, such as bit fields in C structures and network protocol headers. The instructions extract, set, and operate arithmetically and logically on aligned nibble, byte, half-word, and word sub-registers and on unaligned bit fields of arbitrary length and position, reducing instruction count without impacting ALU cycle time or latency. Checksum instructions accelerate ones' complement addition for fast calculation and incremental update of standard 16-bit Internet checksums, including a checksum add that independently sums constituent half words and a checksum fold that folds a wide accumulator down to sixteen bits. A programmable CAM and associated instructions provide key-value lookups using a key format that encodes a selector to locate multiple sub-tables within a single CAM, enabling efficient implementation of switch statements and protocol lookups in a programmable parser.

### CROSS REFERENCE TO RELATED APPLICATIONS

This application is a continuation in part which claims priority to U.S. patent application Ser. No. 19/379,671, filed Nov. 4, 2025 which is a continuation in part to U.S. patent application Ser. No. 18/762,396 filed on Jul. 2, 2024 which is a continuation in part which claims priority to U.S. patent application Ser. No. 17/233,149 filed Apr. 16, 2021 which claims priority to U.S. Provisional Patent Application No. 63/011,002 filed Apr. 16, 2020 which is incorporated in its entirety.

### FIELD OF THE DISCLOSURE

The overall field of this invention relates generally to processor architecture, instruction set architectures, and the acceleration of data processing workloads, and in particular to processor registers and processor instructions for operating on subsets of integer registers, to processor instructions for accelerating Internet checksum computation, and to programmable content-addressable memories and instructions for performing lookups therein. The disclosed embodiments relate to a system and method for sub-register instructions that operate on aligned and unaligned bit fields within integer registers, to checksum add and checksum fold instructions that accelerate ones' complement arithmetic, and to content-addressable memory designs and instructions that accelerate key-value lookups such as those used to implement switch statements and protocol lookups in a programmable parser.

### BACKGROUND

Many important data processing workloads operate on data that is packed densely into machine words. In high-level languages such as C, such densely packed data is frequently expressed as bit fields, which are a common data structure, especially in networking where protocol headers are often specified as structures containing bit fields. A bit field is a data structure that consists of one or more adjacent bits which have been allocated to hold a sequence of bits, stored so that any bit or group of bits can be inspected. Conventional instruction set architectures lack efficient primitives for operating directly on such bit fields, and as a result a compiler typically emits long sequences of shift, mask, and logical instructions to read, modify, and write a bit field. These sequences increase instruction count, code size, and execution latency

A second class of workloads of particular importance in networking is the computation and maintenance of the standard 16-bit Internet checksum, which relies on ones' complement addition. Updating a checksum incrementally, for example as part of Network Address Translation (NAT), or computing a checksum over a header or payload, requires repeated ones' complement additions with carry fold-in. General-purpose instruction sets do not provide native support for ones' complement addition or for folding a wide accumulator down to sixteen bits, and so these operations also expand into many instructions.

A third class of workloads is fast key-value lookup, such as the protocol-number and EtherType lookups performed by a programmable parser. A switch statement in C is elegant in syntax, but compiling it into processor instructions is not straightforward. In the worst case a compiler builds a binary search tree of cases, so searching the tree is O(log 2(N)) where N is the number of cases. Compilers may use a jump table when case values are small integers, but jump tables do not scale when case values are large or sparse; for example, an EtherType lookup could require allocating a 65,536-element array, which is prohibitive. Other techniques use combinations of hashes, Hamming codes, and jump tables, but no software method approaches the efficiency that a content-addressable memory (CAM) can provide for switch statements, which can be as simple as a single lookup that is an O(1) operation.

Accordingly, there is a need for processor registers, processor instructions, and memory structures that reduce the instruction count for operating on densely packed data, that accelerate Internet checksum computation, and that provide efficient programmable key-value lookups, without impacting arithmetic-logic-unit (ALU) cycle time or latency. The present disclosure describes such sub-register instructions, checksum instructions, and programmable content-addressable memories and the instructions used to access them.

### SUMMARY

In some aspects, the techniques described herein relate to a set of sub-register instructions for operating on subsets of integer registers to accelerate workloads where data is packed densely, wherein in high-level language terms the instructions optimize operations on bit fields, wherein a sub-register is a contiguous range of bits in a full register that is accessed and processed as a single unit, wherein the sub-register instructions operate on integer registers and are compatible with both 32-bit and 64-bit architectures, and wherein the sub-register instructions significantly reduce the instruction count for operating on densely packed data without impacting ALU cycle time or latency.

In some aspects, the techniques described herein relate to a sub-register described by a size and a position, wherein a sub-register allows referencing aligned nibble, byte, half-word, and word components of a register explicitly in instructions, wherein size and position are expressed in the assembly for an instruction and in a Sz field and a Pos field of an instruction code, and wherein non-aligned fields of a register or fields with lengths other than a nibble, byte, half-word, or word are extracted or set using a bit position and a bit length expressed in a BitPos field and a BitLength field of an instruction code.

In some aspects, the techniques described herein relate to sub-register operand modes that describe combinations of sub-registers, full registers, and immediates for the destination and operands of a sub-register instruction, wherein a mode is denoted by a destination mode, a first source mode, and a second source mode, wherein each mode indicates that an operand or destination is a sub-register, a sub-register at position zero, a full register, an immediate, or not applicable, and wherein for modes in which the destination is a sub-register, additional bits of the destination outside the sub-register are taken from the existing bits of the destination or, alternatively, from the first operand.

In some aspects, the techniques described herein relate to common operations including extracting a sub-register from a register value, setting a sub-register within a register value while leaving bits outside the sub-register unmodified, sign extending a value, and byte swapping a value to convert endianness.

In some aspects, the techniques described herein relate to sub-register op-immediate instructions, sub-register op instructions with register operands, and sub-register compare-and-branch instructions, for nibble, byte, half-word, and word sub-registers, wherein arithmetic operations include add, and wherein boolean operations include OR and AND, and wherein the compare-and-branch instructions branch on equality, inequality, less-than, and greater-than-or-equal conditions.

In some aspects, the techniques described herein relate to extract and mask instructions for manipulating bit fields of arbitrary length and position within a sixty-four-bit word, including an extract instruction that performs a shift and mask operation, a mask-shift-immediate instruction, a mask-shift instruction, and a mask-nand instruction that inversely masks a contiguous set of bits.

In some aspects, the techniques described herein relate to swap instructions that reverse the endianness of a value in a register, including instructions that swap and set a sub-register, instructions that extract a sub-register and swap it, and an instruction that swaps a full double word.

In some aspects, the techniques described herein relate to checksum instructions that accelerate ones' complement addition for fast calculation of standard 16-bit Internet checksums, including a checksum add instruction that independently performs a 16-bit ones' complement addition on each pair of half words of its arguments, a checksum fold instruction that folds a 64-bit value to a 32-bit value or a 32-bit value to a 16-bit value, and a specialized add-with-carry instruction for incrementally updating a 16-bit checksum in place.

In some aspects, the techniques described herein relate to a programmable content-addressable memory (CAM) used for very fast key-value lookups, wherein the CAM is organized as a table of key-value pairs, wherein a key input into the engine is compared in parallel against all keys and an associated target value is returned upon a match, wherein a CAM key format allows multiple sub-tables to be located within a single CAM table by encoding a selector as part of the key, and wherein processor instructions program entries of the CAM and perform lookups in the CAM.

In some aspects, the techniques described herein relate to the use of a CAM to implement a programming language switch statement, wherein a compiler converts a switch statement to CAM instructions by creating a CAM sub-table for the switch and populating it with an entry for each case, wherein the key for each entry is a case value and the target is an address to which execution jumps on a match, and wherein a default target is configured as the address of a default case.

In some aspects, the techniques described herein relate to the use of a CAM for protocol lookups and other lookups in a protocol parser, wherein parser instructions perform lookups in protocol tables defined as different sub-tables, wherein an input match value is provided in a parser register or parser sub-register, and wherein a default action on a miss is specified by the parser instruction and includes continuing, jumping to a wildcard handler, exiting the parser with success, stopping a sub-node or loop iteration with success, or exiting the parser with failure.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure. Also, the drawings included herein are considered by the applicant to be informal.

FIG. 1 illustrates an ALU datapath for sub-register arithmetic.

FIG. 2 illustrates the position numbering for nibble, byte, half-word, and word sub-registers in big endian representation.

FIG. 3 illustrates the position numbering for nibble, byte, half-word, and word sub-registers in little endian representation.

FIG. 4 illustrates an example processing of an extract instruction.

FIG. 5 illustrates execution of a checksum add instruction in which each half-word is independently summed.

FIG. 6 illustrates a checksum fold of a sixty-four-bit value to a sixteen-bit value.

FIG. 7 illustrates a CAM key structure.

FIG. 8 illustrates an example CAM table.

### DETAILED DESCRIPTION

The following description sets forth, in detail, a sub-register instructions extension, checksum instructions, and programmable content-addressable memories and the instructions used to access them. The subject matter of U.S. patent application Ser. No. 19/379,671, filed Nov. 4, 2025, is incorporated herein by reference in its entirety, and the embodiments described below may be combined with, and employed within, the systems and methods described in that prior application, including without limitation a parser engine, parser registers, parser instructions, and protocol tables described therein.

This specification describes a set of instructions for operating on subsets of integer registers to accelerate workloads where data is packed densely. In high level language terms, such as C, these instructions optimize operations on bit fields. A RISC-V instruction set architecture (ISA) serves as an example ISA that may support sub-register instructions, though the disclosed techniques are not limited to any particular ISA. The extension uses a custom-2 opcode (0x5b) for operations with an immediate operand and a custom-1 opcode (0x2b) for operations with register operands only. The extension is designed to significantly reduce the instruction count for operating on densely packed data without impacting the ALU cycle time or latency.

All sub-register instructions work on the integer registers and are compatible with both 32-bit and 64-bit architectures. A primary use case for sub-registers is to optimize bit fields, examples of which are included in a later section.

In an apparatus embodiment, a processor architecture that implements the sub-register instructions described herein comprises a register file comprising a plurality of full registers, each full register having a predetermined bit width such as 32 bits or 64 bits; an instruction decoder configured to decode an instruction specifying an operation and at least one operand, wherein an operand may define a sub-register comprising a contiguous, arbitrary range of bits within a designated full register; and an execution unit, such as the arithmetic logic unit (ALU) and associated datapath described herein, configured to execute the decoded instruction. The integer registers described herein are examples of the full registers of the register file, and a sub-register is a contiguous range of bits within a designated one of those full registers.

The execution unit executes a decoded sub-register instruction by extracting a value from the sub-register of the designated full register without modifying the designated full register, performing the operation using the extracted value to generate a result, and writing the result to a destination register. When the destination register is a target sub-register within a target full register, the execution unit overwrites only the bits within the contiguous range of the target sub-register while leaving all other bits of the target full register unmodified, as described in connection with the SetSubReg operation and the from_op1 modes. The instruction decoder may identify the sub-register from the instruction in either of the manners described herein: from an instruction opcode encoding a combination of a full register identifier, a start bit offset, and a bit length, wherein the start bit offset and the bit length are encoded as immediate values within the opcode or are retrieved from an index register; or by treating the designated full register as a logical array of sub-words, each sub-word having a bit length that is a power of two, wherein the instruction specifies the sub-register using a combination of a full register identifier, a sub-word size descriptor, and an array index.

Pseudo code describes instruction semantics in a fixed-width font. Temporary variables in pseudocode are prefixed by “Temp”. Field names in instructions are capitalized and italicized, for example: Address. The value of an integer register, for reading or writing, is denoted by Reg [<which>] where <which> is the register number.

Hardware instructions are denoted by all capital letters and prefixed with “SR”; for example SRADD.N. The mnemonics for assembler instructions and any fixed fields for instructions are in regular typeface and variable arguments for assembly instructions are enclosed by angle brackets; for example:

addi.n<rd>[<pos>],<rs>[<pos>],<immed_value>

Common macros and functions may take a number of arguments that are used in the pseudo code for describing the instructions. The notation for a macro argument is _ARG_Name, and if the argument is derived from an instruction field then the notation is _ARG_Name. For example, the extract sub-register macro has the logical prototype ExtractSubReg(_Arg_Val_, _ARG_Sz_, _ARG_Pos_).

Sub-registers allow referencing aligned nibble, byte, and word components of a register explicitly in instructions. There are two parameters to describe a sub-register: size and position. Size and position are expressed in the assembly for an instruction and in the Sz and Pos fields of the instruction code.

Non-aligned fields of a register, or fields with lengths other than a nibble, byte, or word, can be extracted or set in instructions. An unaligned or odd-length bit field is described by two parameters in an instruction: bit position and bit length. Bit position and bit length are expressed in the assembly for an instruction and in the BitPos and BitLength fields of the instruction code.

Assembly instructions using sub-register operands are annotated with size and position information. In an instruction mnemonic, size is indicated by [nbhw] and position is indicated by <reg>[<pos>]. For example, the mnemonic format for the add sub-register instruction is add.[nbhw]<rd>[<pos>],<rs1>[<pos>],<rs2>, and an example use is add.n a0[13], a5[13],a7.

The table below provides the possible sizes with the value set in the Sz field for a sub-register instruction, the assembly mnemonic qualifier for the size, the range of values for the position, and the Sz values for instructions allowing nibble sub-registers and for instructions allowing full registers.

| Canonical | | | | Sz value | Sz value |
|---|---|---|---|---|---|
| size | | Assembly | Position | (nibble sub- | (full |
| value | Size | qualifier | range | registers) | registers) |
| 0 | Nibble (4 | .n | 0 to 15 | 0 | |
| | bits) | | | | |
| 1 | Byte (8 bits) | .b | 0 to 7 | 1 | 1 |
| 2 | Half-word | .h | 0 to 3 | 2 | 2 |
| | (16 bits) | | | | |
| 3 | Word (32 | .w | 0 to 1 | 3 | 3 |
| | bits) | | | | |
| 4 | Double (64 | (none) | 0 | | 0 |
| | bits) | | | | |

For most instructions that use sub-registers, the Sz field corresponds to 0 for nibbles, 1 for bytes, 2 for half-words, and 3 for words, such that the number of bits in the sub-register value is 4*(1<<Sz). For swap, checksum add, and checksum fold instructions, the Sz field corresponds to 1 for bytes, 2 for half-words, 3 for words, and 0 for double words, such that the number of bits in the sub-register value is 4*(1<<Sz) for Sz equal to 1, 2, or 3, or 64 for Sz equal to 0. The instructions that use this alternate meaning for Sz equal to 0 are denoted as such below.

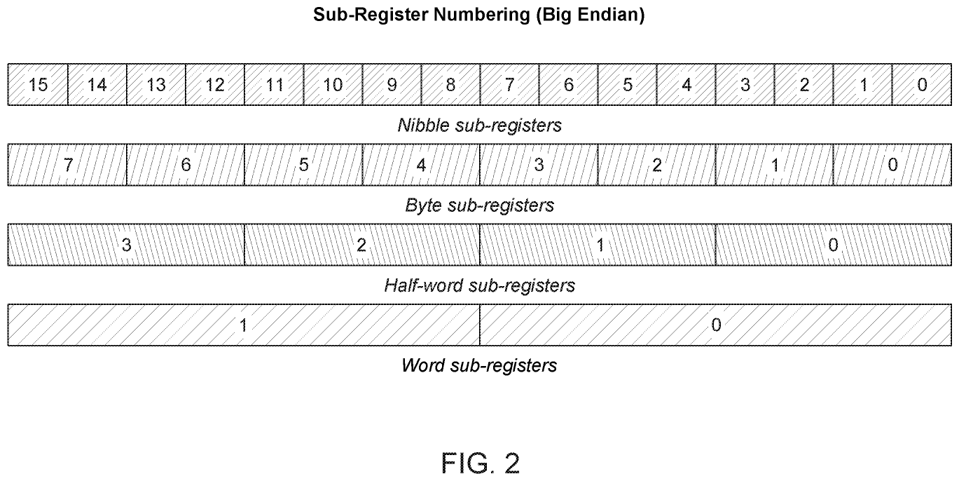

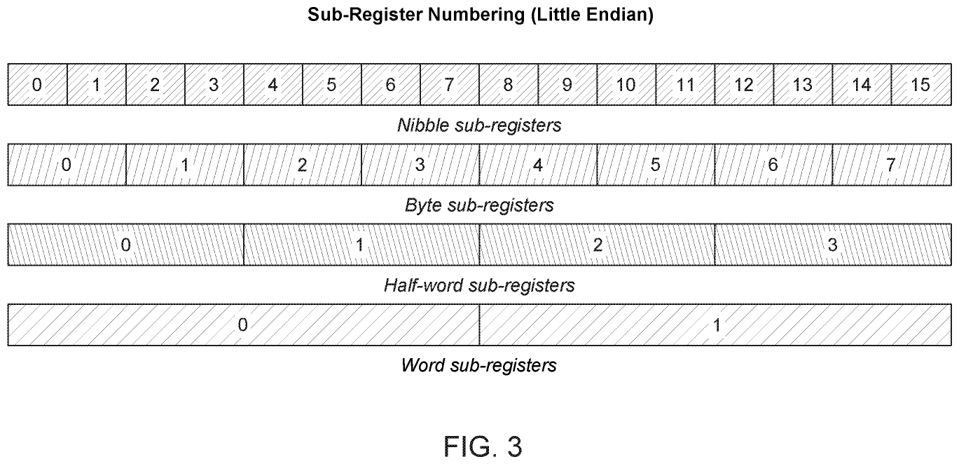

The position of a sub-register indicates the position of the nibble, byte, half-word, or word. Sub-registers are counted from the first byte in memory being the zero position (the low order byte in a little endian word). Nibbles are numbered such that the high order four bits in a byte are a lower numbered nibble than the four low order bits of the byte; e.g., nibble number zero is the four high order bits of the first byte, and nibble number one is the four low order bits of the first byte. FIG. 2 and FIG. 3 illustrate the position numbering for nibble, byte, half-word, and word sub-registers in big endian and little endian representations, respectively.

Bit position is a value in the range 0 to 63 inclusive. Bit length is a value between 1 and 64 minus the bit position, so that bit length plus bit position is less than or equal to 64. Bits are canonically numbered per the endianness of the system; the basic extraction function is:

In an apparatus embodiment, the execution unit extracts the value from a sub-register by right-shifting the designated full register by a bit offset of the sub-register to create an intermediate value, and masking low-order bits of the intermediate value with a bitmask corresponding to a length of the sub-register, consistent with the ExtractSubReg operation described herein. The execution unit may be further configured to conditionally sign-extend the extracted value into an internal register of the execution unit when a high-order bit of the sub-register is set to one, consistent with the SignExtend operation described herein, the internal register being a register internal to the execution unit that holds the extracted operand value while the operation is performed. Conversely, the execution unit writes a result to a target sub-register by masking low-order bits of the result to match a length of the target sub-register, left-shifting the masked result by a bit offset of the target sub-register, zeroing out the bits within the contiguous range of the target sub-register in the target full register, and bitwise ORing the shifted, masked result with the target full register, consistent with the SetSubReg operation described herein.

res=(input>>bpos)&((1ULL<<blen)−1);

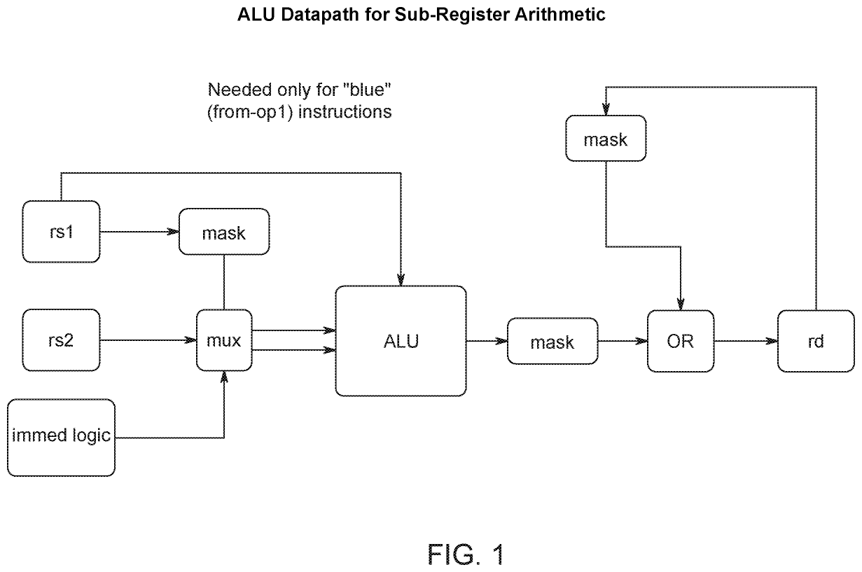

FIG. 1 illustrates, for example only and not as a complete microarchitecture, an ALU datapath for sub-register arithmetic. A first source operand rs1 and a second source operand rs2 are provided to an ALU. An immediate logic block and a multiplexer select the second operand as either a register value or an immediate value. A mask is applied to the ALU output to select the bits of the sub-register, and an OR stage combines the masked result with bits taken from the first operand or the destination to produce the destination value rd. Additional masking of the first operand is provided in embodiments that support the from_op1 modes described below.

Sub-register operand modes describe the various combinations of sub-registers and full registers for the operands and destination of sub-register instructions. Each sub-register instruction can be categorized by its mode. A sub-register mode is denoted by <dst-mode>_<src1-mode>_<src2-mode>, where <dst-mode> indicates the mode for the destination, <src1-mode> indicates the mode for the first operand, and <src2-mode> indicates the mode for the second operand. For each of these, the mode can be s, s0, r, i, or x. The mode s indicates that the operand or destination is a sub-register; s0 indicates that the operand or destination is the sub-register at position zero; r indicates that the operand or destination is a full register; i indicates that the operand is an immediate; and x indicates the operand or destination is not applicable for an instruction. If an instruction has only a destination and one source operand, the x for the second operand may be dropped in the notation.

For the modes in which the destination is a sub-register, the procedure for deriving the additional bits set in the destination register, those not part of the sub-register being operated on, is specified. By default, the additional bits are taken to be the existing bits in the destination register. To facilitate hardware implementation, an alternative mechanism takes the additional bits from the first operand; this is denoted by the _from_op1 suffix.

The sub-register operand modes for instructions that have a destination and two operands are:

r_r_s: The first operand and destination are full registers; the second operand is a sub-register.

r_r_r: Both operands and the destination are full registers.

r_r_i: The first operand and destination are full registers; the second operand is an immediate.

s_s_s/s_s_s_from_op1: Both source registers and the destination register are sub-registers of the same size as indicated by the size field, and all share the same position as indicated by the position field.

s_s_s0/s_s_s0_from_op1: Both source registers and the destination register are sub-registers of the same size; the first operand and the destination have the sub-register position from the instruction field, and the second operand is the subreg[0] variant.

s_s_r/s_s_r_from_op1: The first operand and destination are sub-registers of the same size and position as indicated in the instruction fields, and the second operand is a full register.

s_s_i/s_s_i_from_op1: The destination and first operand are sub-registers of the same size and position as indicated in the instruction fields, and the second operand is an immediate.

The sub-register operand modes for instructions that have a destination and one operand are:

r_s: The operand is a sub-register, and the destination is a full register.

r_r: The operand and the destination are full registers.

r_i: The operand is an immediate, and the destination is a full register.

s s/s_s_from_op1: Both the operand and the destination register are sub-registers of the same size and position.

s_r: The operand is a full register and the destination is a sub-register.

s_i: The operand is an immediate and the destination is a sub-register.

The sub-register operand modes for instructions that have no destination and two operands are:

x_r_r: Both operands are full registers.

x_S_s: Both operands are sub-registers of the same size and position.

x_s_r: The first operand is a sub-register and the second is a full register.

x_s_i: The first operand is a sub-register and the second operand is an immediate.

This section describes macros for common pseudo code used throughout this disclosure.

```
  Extract a sub-register (ExtractSubReg). Returns the sub-register value
from a register value:
  // TempVal = ExtractSubReg(_{——}Arg_Val_{——}, _{——}ARG_Sz_{——},
_{——}ARG_Pos_{——})
  // _{——}ARG_Val_{——} is the value argument, _{——}ARG_Sz_{——} is the size,
  // _{——}ARG_Pos_{——} is the sub-register position
```

| | |
|---|---|
| if (_{——}ARG_Sz_{——} == 4) | // Full register |

```
  return _{——}ARG_Val_{——};
  TempNumBits = (1 << _{——}ARG_Sz_{——}) * 4;
```

| | |
|---|---|
| if (_{——}ARG_Sz_{——} == 0) { | // Extract nibble |

```
    TempShift = 8 * (_{——}ARG_Pos_{——} / 2);
    if ((_{——}ARG_Pos_{——} & 1))
  TempShift += 4;
```

| | |
|---|---|
| } else { | // Byte, half-word, or word |

```
  TempShift = TempNumBits * _{——}ARG_Pos_{——};
  }
  TempMask = (1 << TempNumBits) − 1;
  Temp = (_{——}ARG_Val_{——} >> TempShift) & TempMask;
  return Temp;
  Set a sub-register (SetSubReg). Returns a register value with a sub-
register set
  // TempVal = SetSubReg(_{——}ARG_Val_{——}, _{——}ARG_Other_Src_{——},
```

| | |
|---|---|
| // | _{——}ARG_Sz_{——}, _{——}ARG_Pos_{——}) |

```
  // _{——}ARG_Val_{——} is the value argument, _{——}ARG_Sz_{——} is the size,
  // _{——}ARG_Other_Src_{——} provides the bits to set in the destination
  // outside the sub-register, _{——}ARG_Pos_{——} is the sub-register position
```

| | |
|---|---|
| if (_{——}ARG_Sz_{——} == 4) | // Full register |

```
  return _{——}ARG_Val_{——};
  TempNumBits = (1 << _{——}ARG_Sz_{——}) * 4;
```

| | |
|---|---|
| if (_{——}ARG_Sz_{——} == 0) { | // Set nibble |

```
  TempShift = 8 * (_{——}ARG_Pos_{——} / 2);
  if ((_{——}ARG_Pos_{——} & 1))
  TempShift += 4;
```

| | |
|---|---|
| } else { | // Byte, half-word, or word |

```
  TempShift = TempNumBits * _{——}ARG_Pos_{——};
  }
  TempMask = ((1 << TempNumBits) − 1) << TempShift;
  Temp = (_{——}ARG_Other_Src_{——} & ~TempMask) |
  ((_{——}ARG_Val_{——} << TempShift) & TempMask);
  return Temp;
  Sign extend a value (SignExtend). Returns the sign extended value for the
input:
  // TempVal = SignExtend(_{——}ARG_Val_{——}, _{——}ARG_Sign_Bit_{——})
  // _{——}ARG_Val_{——} is the value argument, _{——}ARG_Sign_Bit_{——} is the bit
  // position of the sign bit
  TempRes = _{——}ARG_Val_{——};
  if (_{——}ARG_Val_{——} & (1 << _{——}ARG_Sign_Bit_{——})) {
  TempHighBits = ~((1 << _{——}ARG_Sign_Bit_{——}) − 1);
  TempRes |= TempHighBits;
  }
  return TempRes;
  Byte swap a value (ByteSwap). Returns the value with a byte swap to
convert endianness, where_{——}ARG_Sz_{——} is 2 for half-words, 3 for words, or 4 for double words:
  // TempVal = ByteSwap(_{——}ARG_Val_{——}, _{——}ARG_Sz_{——})
  if (_{——}ARG_Sz_{——} == 2) {
  Temp = ((_{——}ARG_Val_{——} << 8) & 0xFF00) |
    ((_{——}ARG_Val_{——} >> 8) & 0xFF);
  return Temp;
  } else if (_{——}ARG_Sz_{——} == 3) {
  Temp = ((_{——}ARG_Val_{——} << 24) & 0xFF000000) |
    ((_{——}ARG_Val_{——} << 8) & 0xFF0000) |
    ((_{——}ARG_Val_{——} >> 8) & 0xFF00) |
    ((_{——}ARG_Val_{——} >>24) & 0xFF);
  return Temp;
```

| | |
|---|---|
| } else { | // _{——}ARG_Sz_{——} == 4 |

```
  Temp = ((_{——}ARG_Val_{——} << 56) & 0xFF00000000000000) |
  ((_{——}ARG_Val_{——} << 40) & 0xFF000000000000) |
    ((_{——}ARG_Val_{——} << 24) & 0xFF0000000000) |
  ((_{——}ARG_Val_{——} << 8) & 0xFF00000000) |
    ((_{——}ARG_Val_{——} >> 8) & 0xFF000000) |
  ((_{——}ARG_Val_{——} >> 24) & 0xFF0000) |
  ((_{——}ARG_Val_{——} >> 40) & 0xFF00) |
  ((_{——}ARG_Val_{——} >> 56) & 0xFF);
  return Temp;
  }
```

Sub-register instructions are defined with the custom-1 and custom-2 opcodes. A three-bit field, func3, defines sub-operations. For custom-1, bit #31 (the S-bit) is used to define two classes of major sub-operations. The following tables summarize the sub-register instructions defined by the func3 field.

Sub-register instructions with an immediate operand (custom-2 opcode):

| func3 | func3 | |
|---|---|---|
| (decimal) | (binary) | Instruction(s) |
| 0 | 000 | SRADDI.N, SRADDI.B, SRADDI.H, SRADDI.W |
| 1 | 001 | SRBEQI.N, SRBEQI.B, SRBEQI.H, SRBEQI.W |
| 2 | 010 | SRSETI.N, SRSETI.B, SRSETI.H, SRSETI.W |
| 3 | 011 | SRBLTI.N, SRBLTI.B, SRBLTI.H, SRBLTI.W |
| 4 | 100 | SRBNEI.N, SRBNEI.B, SRBNEI.H, SRBNEI.W |
| 5 | 101 | SRBGEI.N, SRBGEI.B, SRBGEI.H, SRBGEI.W |
| 6 | 110 | SRORI.B, SRADDWCI.H |
| 7 | 111 | SRANDI.B |

Sub-register instructions with all register operands (custom-1 opcode with bit #31 not set):

| func3 | func3 | |
|---|---|---|
| (decimal) | (binary) | Instruction(s) |
| 0 | 000 | SRADD.N, SRADD.B, SRADD.H, SRADD.W |
| 1 | 001 | SRBEQ.N, SRBEQ.B, SRBEQ.H, SRBEQ.W |
| 2 | 010 | SRSET.N, SRSET.B, SRSET.H, SRSET.W |
| 3 | 011 | SRBLT.N, SRBLT.B, SRBLT.H, SRBLT.W |
| 4 | 100 | SRBNE.N, SRBNE.B, SRBNE.H, SRBNE.W |
| 5 | 101 | SRBGE.N, SRBGE.B, SRBGE.H, SRBGE.W |
| 6 | 110 | SROR.N, SROR.B, SROR.H, SROR.W |
| 7 | 111 | SRAND.N, SRAND.B, SRAND.H, SRAND.W |

Miscellaneous sub-register instructions with all register operands (custom-1 opcode with bit #31 set):

| func3 | func3 | |
|---|---|---|
| (decimal) | (binary) | Instruction(s) |
| 0 | 000 | SREXTRACT |
| 1 | 001 | SRSWAPSET.H, SRSWAPSET.W, SRSWAP.D, |
| | | SRSWAPEXT.H, SRSWAPEXT.W |
| 2 | 010 | SRCSUMADD.B, SRCSUMADD.H, |
| | | SRCSUMADD.W, SRCSUMADD.D |
| 3 | 011 | SRCADDWC.H |
| 4 | 100 | SRCSUMFOLD.W, SRCSUMFOLD.D |
| 5 | 101 | SRMASKSHIFTI |
| 6 | 110 | SRMASKNAND |
| 7 | 111 | SRMASKSHIFT |

Each instruction is encoded in a 32-bit instruction word. For immediate-operand instructions, the instruction word includes an S-bit, a position field Pos, a size field Sz (where present), an immediate field Imm, a source register field Rs, the func3 field, a destination field Rd or an offset field Offset for branch instructions, and the opcode field. For register-operand instructions, the immediate field is replaced by a second source register field Rs2 and the source field is Rs1. The position field is encoded according to the sub-register size such that, for byte sub-registers the encoding is 0,Pos[2:0] with Sz equal to 01; for half-word sub-registers the encoding is 00,Pos[1:0] with Sz equal to 10; and for word sub-registers the encoding is 000,Pos[0] with Sz equal to 11; and for nibble sub-registers the full Pos field is used with Sz equal to 00.

This section describes sub-register instructions that have an immediate operand. These instructions use the custom-2 opcode (0x5B).

These instructions perform an ALU operation on one nibble of a source register. For each instruction, one nibble is selected based on the nibble position Pos value from the source register, the ALU operation is performed with the 5-bit Imm, and the result is placed in the nibble position Pos of the destination register. The remaining nibbles of the source register are transferred to the destination register unmodified. The SRADDI.N instruction adds the immediate to the selected nibble; the set instruction SRSETI.N sets the nibble in position Pos to the immediate value.

Pseudo code for SRADDI.N (Mode: s_s_i_from_op1):
Temp = ExtractSubReg(Reg[<Rs>], 0, Pos);
Temp += Imm;
Reg[<Rd>] = SetSubReg(Temp, Reg[<Rs>], 0, Pos);
Pseudo code for SRSETI.N (Mode: s_s_i_from_op1):
Reg[<Rd>] = SetSubReg(Imm, Reg[<Rs>], 0, Pos);

In assembly, SRADDI.N is written addi.n <rd>[<pos>],<rs>[<pos>],<immed_value> and SRSETI.N is written srseti.n <rd>[<pos>],<rs>[<pos>],<immed_value>, where <rd> is an integer destination register (not zero), <rs> is an integer source register, <pos> is the sub-register index in the range 0 to 15 inclusive (all sub-registers must use the same <pos>), and <immed_value> is a value in the range 0 to 15 inclusive.

Sub-register nibble compare-and-branch instructions branch if the condition is met. The branch is a short forward-only branch; the offset is a 5-bit unsigned value in Offset that is shifted left by one, plus six, and added to the PC. The added value of six accounts for the four-byte length of the branch instruction and the requirement that forward jumps must be at least over one instruction. The position is indicated by Pos. SRBEQI.N branches if the value in the position is equal to the immediate value; SRBNEI.N branches if not equal; SRBLTI.N branches if less than; and SRBGEI.N branches if greater than or equal to the immediate value.

```
  Pseudo code for SRBEQI.N / SRBNEI.N / SRBLTI.N / SRBGEI.N
(Mode: x_s_i):
  Temp = ExtractSubReg(Reg[<Rs>], 0, Pos);
  if (Temp == Imm) GOTO PC + (Offset << 1) + 6 // SRBEQI.N
  if (Temp != Imm) GOTO PC + (Offset << 1) + 6 // SRBNEI.N
  if (Temp < Imm) GOTO PC + (Offset << 1) + 6 // SRBLTI.N
  if (Temp >= Imm) GOTO PC + (Offset << 1) + 6 // SRBGEI.N
```

In assembly, these are written beqi.n/bnei.n/blti.n/bgei.n <rs>[<pos>],<immed_value>,<address>, where <rs> is an integer register, <pos> is in the range 0 to 15 inclusive, <immed_value> is in the range 0 to 15 inclusive, and <address> is the branch target address.

These instructions perform an ALU operation on one byte of a source register selected by the byte position Pos, with an 8-bit Imm, placing the result in the byte position Pos of the destination register and transferring the remaining bytes unmodified. The instructions include SRADDI.B (add), SRORI.B (or), SRANDI.B (and), and SRSETI.B (set).

```
  Pseudo code for SRADDI.B / SRORI.B / SRANDI.B (Mode:
s_s_i_from_op1):
  Temp = ExtractSubReg(Reg[<Rs>], 1, Pos);
  Temp += Imm; // SRADDI.B
  Temp |= Imm; // SRORI.B
  Temp &= Imm; // SRANDI.B
  Reg[<Rd>] = SetSubReg(Temp, Reg[<Rs>], 1, Pos);
  Pseudo code for SRSETI.B (Mode: s_s_i_from_op1):
  Reg[<Rd>] = SetSubReg(Imm, Reg[<Rs>], 1, Pos);
```

In assembly these are written addi.b, ori.b, andi.b, and srseti.b in the form <rd>[<pos>],<rs>[<pos>],<immed_value>, where <pos> is in the range 0 to 7 inclusive and <immed_value> is in the range 0 to 255 inclusive.

Sub-register byte compare-and-branch instructions (SRBEQI.B, SRBNEI.B, SRBLTI.B, SRBGEI.B) branch if the condition is met using the same short forward-only branch offset computation described for the nibble compare-and-branch instructions. One byte is selected based on the byte position Pos and compared to the 8-bit immediate value.

Temp = ExtractSubReg(Reg[<Rs>], 1, Pos);
if (Temp == Imm) GOTO PC + (Offset << 1) + 6; // SRBEQI.B
if (Temp != Imm) GOTO PC + (Offset << 1) + 6; // SRBNEI.B
if (Temp < Imm) GOTO PC + (Offset << 1) + 6; // SRBLTI.B
if (Temp >= Imm) GOTO PC + (Offset << 1) + 6; // SRBGEI.B

In assembly these are written beqi.b/bnei.b/blti.b/bgei.b <rs>[<pos>],<immed_value>,<address>, where <pos> is in the range 0 to 7 inclusive and <immed_value> is in the range 0 to 255 inclusive.

These instructions perform an ALU operation on a half-word of a source register. For each instruction, one half-word is selected based on the half-word position Pos value, and the ALU operation is performed with the 5-bit Imm sign extended to 16 bits. The result is placed in the half-word position Pos of the destination register and the remaining half-words are transferred unmodified. The SRADDWCI.H instruction is a special add with carry that performs a ones' complement addition on a 16-bit value: if the sign-extended immediate added to the value in the position of Rs would produce a carry out, then the result is the addition of the sign-extended immediate plus the value in the position of Rs plus an additional 1; otherwise the result is just the addition. This is an operation optimized for updating a 16-bit checksum value based on a small delta value.

Pseudo code for SRADDI.H (Mode: s_s_i_from_op1):
Temp = ExtractSubReg(Reg[<Rs>], 2, Pos);
TempImm = SignExtend(Imm, 4);
Temp += TempImm;
Reg[<Rd>] = SetSubReg(Temp, Reg[<Rs>], 2, Pos);
Pseudo code for SRADDWCI.H (Mode: s_s_i_from_op1):
Temp = ExtractSubReg(Reg[<Rs>], 2, Pos);
Temp += Imm;
TempCarry = Temp >> 16;
TempRes = (Temp & 0xFFFF) + TempCarry;
Reg[<Rd>] = SetSubReg(TempRes, Reg[<Rs>], 2, Pos);
Pseudo code for SRSETI.H (Mode: s_s_i_from_op1):
TempImm = SignExtend(Imm, 4);
Reg[<Rd>] = SetSubReg(TempImm, Reg[<Rs>], 2, Pos);

In assembly these are written addi.h, addwc.h, and srseti.h in the form <rd>[<pos>],<rs>[<pos>],<immed_value>, where <pos> is in the range 0 to 3 inclusive and <immed_value> is in the range 0 to 0x1F inclusive (the high order bit, bit #4, is sign extended to 16 bits before the arithmetic operation).

### Sub-Register Half-Word Compare Immediate and Branch

Sub-register half-word compare-and-branch instructions (SRBEQI.H, SRBNEI.H, SRBLTI.H, SRBGEI.H) branch if the condition is met using the short forward-only branch offset computation described above. For the equality and inequality comparisons, the extracted half-word value and the immediate are each sign extended before comparison.

Temp = ExtractSubReg(Reg[<Rs>], 2, Pos);
Temp = SignExtend(Temp, 15); // SRBEQI.H / SRBNEI.H
TempImm = SignExtend(Imm, 4);
if (Temp == TempImm) GOTO PC + (Offset << 1) + 6; // SRBEQI.H
if (Temp != TempImm) GOTO PC + (Offset << 1) + 6; // SRBNEI.H
if (Temp < Imm) GOTO PC + (Offset << 1) + 6; // SRBLTI.H
if (Temp >= Imm) GOTO PC + (Offset << 1) + 6; // SRBGEI.H

In assembly these are written beqi.h/bnei.h/blti.h/bgei.h <rs>[<pos>],<immed_value>,<address>, where <pos> is in the range 0 to 3 inclusive and <immed_value> is in the range 0 to 0x1F inclusive.

### Sub-Register Word Op-Immediate Instructions

These instructions perform an ALU operation on a word of a source register. For each instruction, one word is selected based on the word position Pos value, and the ALU operation is performed with the 5-bit Imm sign extended to 32 bits. The result is placed in the word position Pos of the destination register and the remaining word is transferred unmodified. The instructions include SRADDI.W (add) and SRSETI.W (set).

Pseudo code for SRADDI.W (Mode: s_s_i_from_op1):
Temp = ExtractSubReg(Reg[<Rs>], 3, Pos);
TempImm = SignExtend(Imm, 4);
Temp += TempImm;
Reg[<Rd>] = SetSubReg(Temp, Reg[<Rs>], 3, Pos);
Pseudo code for SRSETI.W (Mode: s_s_i_from_op1):
TempImm = SignExtend(Imm, 4);
Reg[<Rd>] = SetSubReg(TempImm, Reg[<Rs>], 3, Pos);

In assembly these are written addi.w and seti.w in the form <rd>[<pos>],<rs>[<pos>],<immed_value>, where <pos> is in the range 0 to 1 inclusive and the immediate is in the range 0 to 0x1F inclusive (bit #4 sign extended to 32 bits).

### Sub-Register Word Compare Immediate and Branch

Sub-register word compare-and-branch instructions (SRBEQI.W, SRBNEI.W, SRBLTI.W, SRBGEI.W) branch if the condition is met using the short forward-only branch offset computation described above. One word is selected based on the word position Pos and compared to the sign-extended immediate value.

Temp = ExtractSubReg(Reg[<Rs>], 3, Pos);
if (Temp == Imm) GOTO PC + (Offset << 1) + 6 // SRBEQI.W
if (Temp != Imm) GOTO PC + (Offset << 1) + 6 // SRBNEI.W
if (Temp < Imm) GOTO PC + (Offset << 1) + 6 // SRBLTI.W
if (Temp >= Imm) GOTO PC + (Offset << 1) + 6 // SRBGEI.W

In assembly these are written beqi.w/bnei.w/blti.w/bgei.w <rs>[<pos>],<immed_value>,<address>.

This section describes sub-register instructions that have all register operands. These instructions use the custom-1 opcode (0x2B) with the S-bit, bit #31, not set.

### Sub-Register Nibble, Byte, Half-Word, and Word Op Instructions

These instructions perform an ALU operation on one sub-register from a first source register Rs1 and a full second source register Rs2, and place the value in the corresponding sub-register position of the destination register. For each instruction, one sub-register is selected from Rs1 based on the position Pos and the ALU operation is performed with Rs2 (which is not a sub-register). The result is placed in the position Pos of the destination register, and the remaining sub-registers of Rs1 are transferred to the destination register unmodified. The arithmetic operation is add (SRADD), and the boolean operations are or (SROR) and and (SRAND). The set instruction (SRSET) sets the sub-register in position Pos to the value from the sub-register in position Pos of Rs2.

```
  Pseudo code for SRADD / SROR / SRAND (Mode:
s_s_r_from_op1), where SZ is 0, 1, 2, or 3 for .N, .B, .H, or .W:
  Temp = ExtractSubReg(Reg[<Rs1>], SZ, Pos);
  TempRes = Temp + Reg[<Rs2>]; // SRADD
  TempRes = Temp | Reg[<Rs2>]; // SRO
  TempRes = Temp & Reg[<Rs2>]; // SRAND
  Reg[<Rd>] = SetSubReg(TempRes, Reg[<Rs1>], SZ, Pos);
  Pseudo code for SRSET (Mode: s_s_r_from_op1):
  Reg[<Rd>] = SetSubReg(Reg[<Rs2>], Reg[<Rs1>], SZ, Pos);
```

In assembly these are written add.[nbhw], or.[nbhw], and.[nbhw], and set.[nbhw] (or srset.[nbhw]) in the form <rd>[<pos>],<rs1>[<pos>],<rs2>, where <rd> is an integer destination register (not zero), <rs1> and <rs2> are integer registers, and <pos> is in the range appropriate for the sub-register size (0 to 15 for nibble, 0 to 7 for byte, 0 to 3 for half-word, and 0 to 1 for word).

### Sub-Register Compare and Branch (Register Operands)

Sub-register compare-and-branch instructions with register operands branch if the condition is met using the short forward-only branch offset computation described above. For each instruction, one sub-register is selected from Rs1 based on the position Pos and the compare operation is performed with Rs2 (not a sub-register). SRBEQ branches on equality, SRBNE on inequality, SRBLT on less-than, and SRBGE on greater-than-or-equal, in each case relative to the value in Rs2. These are defined for nibble (.N), byte (.B), half-word (.H), and word (.W) sub-registers.

```
  Temp = ExtractSubReg(Reg[<Rs1>], SZ, Pos);
  if (Temp == Reg[<Rs2>]) GOTO PC + (Offset << 1) + 6 // SRBEQ
  if (Temp != Reg[<Rs2>]) GOTO PC + (Offset << 1) + 6 // SRBNE
  if (Temp < Reg[<Rs2>]) GOTO PC + (Offset << 1) + 6 // SRBLT
  if (Temp >= Reg[<Rs2>]) GOTO PC + (Offset << 1) + 6 // SRBGE
  In assembly these are written beq.[nbhw] / bne.[nbhw] / blt.[nbhw] /
bge.[nbhw] <rs1>[<pos>],<rs2>,<address>.
```

### Miscellaneous Instructions

This section describes miscellaneous sub-register instructions. These instructions use the custom-1 opcode (0x2B) with the S-bit, bit #31, set.

### Extract and Mask Instructions

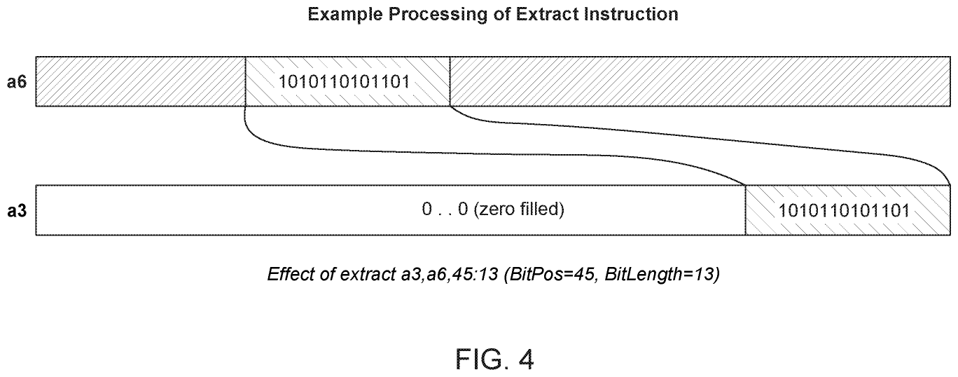

This set of instructions is targeted to manipulating bit fields of arbitrary length and position in a sixty-four-bit word. FIG. 4 illustrates an example processing of an extract instruction, showing the effect of extract a3, a6,45:13, in which a thirteen-bit field at bit position 45 of register a6 is shifted and masked into the low-order bits of register a3 and the high-order bits of a3 are set to zero.

The SREXTRACT instruction performs a shift and mask operation on the register in Rs to obtain a value of the appropriate size in the low-order bits of the destination register; the high-order bits of the destination register are set to zero. The bit position is taken from BitPos and the size is taken from BitLength. This is a general instruction that allows extracting a bit field up to thirty-two bits in length from an arbitrary position in a register. Alias instructions for extracting sub-registers are created by setting BitPos and BitLength appropriately. For instance, to extract nibble number 13 from a register, BitPos would be forty-eight and BitLength would be four (BitPos is forty-eight in this case to account for nibble ordering where the high order nibble in a byte is the first nibble).

The SRMASKSHIFTI instruction masks the lower order bits of an immediate value for length BitLength and then left shifts the result by BitPos. The SRMASKNAND (“mask nand”) instruction allows inverse masking of a contiguous set of bits in a register: the mask has a starting position in BitPos and a length in BitLength, and the operation zeroes the bits in the range while copying bits outside the range from the source register. The SRMASKSHIFT instruction masks the lower order bits in the source register for BitLength and then left shifts the result by BitPos.

```
  Pseudo code for SREXTRACT (Mode: r_r), SRMASKSHIFTI (Mode:
r_i), SRMASKSHIFT (Mode: r_r), and SRMASKNAND (Mode: r_r):
  // SREXTRACT
  Reg[<Rd>] = (Reg[<Rs>] >> BitPos) & ((1 << BitLength) − 1);
  // SRMASKSHIFTI
  Temp = SignExtend(Immed, 4);
  Reg[<Rd>] = (Temp & ((1 << BitLength) − 1)) << BitPos;
  // SRMASKSHIFT
  Reg[<Rd>] = (Reg[<Rs>] & ((1 << BitLength) − 1)) << BitPos;
  // SRMASKNAND
  Reg[<Rd>] = Reg[<Rs>] & ~(((1 << BitLength) − 1) << BitPos);
```

In assembly these are written extract <dst>,<rs>,<bit_pos>:<bit_len> (with aliases extract.n, extract.b, extract.h, and extract.w for sub-register extraction), maskshifti <dst>,<immed>,<bit_pos>:<bit_len>, masknand <dst>,<rs>,<bit_pos>:<bit_len>, and maskshift <dst>,<rs>,<bit_pos>:<bit_len>. Here <bit_pos> is in the range 0 to 63 inclusive, <bit_len> is in the range 1 to 32 inclusive, and <bit_pos>+<bit_len> must be less than or equal to sixty-four.

The nibble extract alias uses BitPos=2*(<pos>/2)+4*((<pos>+1) & 1) and BitLength=4; the byte alias uses BitPos=8*<pos> and BitLength=8; the half-word alias uses BitPos=16*<pos> and BitLength=16; and the word alias uses BitPos=32*<pos> and BitLength=32.

### Swap Instructions

The swap instruction performs a byte swapping to reverse the endianness of a value in a register. The Sz field maps a value of 1 to a byte, 2 to a half-word, 3 to a word, and 0 to a double word (i.e., 1, 2, 4, or 8 bytes). SRSWAPSET.H and SRSWAPSET. W swap the bytes in the Rs2 register, for half-words and words respectively, and then set the value in the <Rd> sub-register taking the additional bytes not in the sub-register from <Rs1>; Pos is the sub-register position. SRSWAPEXT.H and SRSWAPEXT. W extract the sub-register value from <Rs1>, swap the bytes in the value, and set <Rd> to the result. SRSWAP.D swaps the bytes of <Rs1> and sets the value in <Rd>.

// SRSWAPSET.H / SRSWAPSET.W (Mode: s_s_r_from_op1)
Temp = ByteSwap(Reg[<Rs2>], SZ); // SZ = 2 or 3
Reg[<Rd>] = SetSubReg(Temp, Reg[<Rs1>], SZ, Pos);
// SRSWAPEXT.H / SRSWAPEXT.W (Mode: r_s)
Temp = ExtractSubReg(Reg[<Rs1>], SZ, Pos);// SZ = 2 or 3
Reg[<Rd>] = ByteSwap(Temp, SZ);
// SRSWAP.D (Mode: r_r)
Reg[<Rd>] = ByteSwap(Reg[<Rs1>], 4);

In assembly these are written swap.h.set/swap.w.set <dst>[<pos>],<rs1>[<pos>],<rs2>, swap.h.extract/swap.w.extract <dst>,<rs>[<pos>], and swap <dst>,<rs>. Where <pos> is present for a half-word the range is 0 to 3 inclusive, and for a word the range is 0 to 1 inclusive.

### Checksum Instructions

Two base instructions are defined to accelerate ones' complement addition for fast calculation of standard 16-bit Internet checksums: SRCSUMADD and SRCSUMFOLD. Additionally, SRADDWC.H is a specialized instruction for updating checksums in sub-registers.

### Checksum Add Instructions

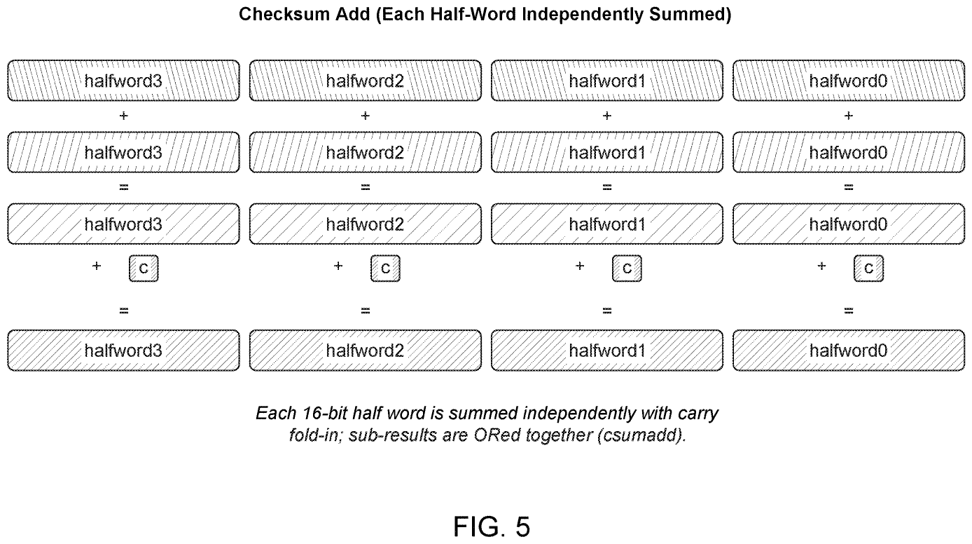

SRCSUMADD performs a “checksum add” of two registers. The algorithm independently performs a 16-bit ones' complement addition on each of the half words comprising the arguments and then ORs each sub-result together. Due to the associativity of the Internet checksum, this algorithm yields a result that is mathematically correct. FIG. 5 illustrates execution of a checksum add instruction in which each half-word is independently summed.

The algorithm works as follows. For 16-bit arguments, the two values are summed and any carry is added back in. For adding two 32-bit values, two 16-bit ones' complement additions are performed: the low order half word of both arguments are summed and any carry is added back into the result to form the low order 16 bits of the result; similarly the upper 16 bits of each argument are summed and any carry is added back into the result to form the high order 16 bits. Adding two 64-bit values works similarly, with four 16-bit add operations performed with carry fold-in on each of the four half words.

```
  Pseudo code for SRCSUMADD.B / SRCSUMADD.H (Mode: r_r_s),
where SZ is 1 or 2:
  Temp = ExtractSubReg(Reg[<Rs2>], SZ, Pos);
  TempSum = (Reg[<Rs1>] & 0xFFFF) + Temp
  TempSum += TempSum >> 16;
  TempSum = TempSum & 0xFFFF;
  Reg[<Rd>] = TempSum | (Reg[<Rs1>] & ~0xFFFF);
  Pseudo code for SRCSUMADD.W (Mode: r_r_s):
  Temp = ExtractSubReg(Reg[<Rs2>], 3, Pos);
  TempSum1 = (Reg[<Rs1>] & 0xFFFF) + (Temp & 0xFFFF);
  TempSum1 += TempSum1 >> 16;
  TempSum1 = TempSum1 & 0xFFFF;
  TempSum2 = ((Reg[<Rs1>] >> 16) & 0xFFFF) + (Temp >> 16);
  TempSum2 += TempSum2 >> 16;
  TempSum2 = TempSum2 & 0xFFFF;
  Reg[<Rd>] = TempSum1 | (TempSum2 << 16) |
  (Reg[<Rs1>] & ~0xFFFFFFFF);
  Pseudo code for SRCSUMADD.D (Mode: r_r_s):
  Temp = Reg[<Rs2>];
  TempSum1 = (Reg[<Rs1>] & 0xFFFF) + (Temp & 0xFFFF);
  TempSum1 += TempSum1 >> 16; TempSum1 &= 0xFFFF;
  TempSum2 = ((Reg[<Rs1>] >> 16) & 0xFFFF) + ((Temp >> 16) &
0xFFFF);
  TempSum2 += TempSum2 >> 16; TempSum2 &= 0xFFFF;
  TempSum3 = ((Reg[<Rs1>] >> 32) & 0xFFFF) + ((Temp >> 32) &
0xFFFF);
  TempSum3 += TempSum3 >> 16; TempSum3 &= 0xFFFF;
  TempSum4 = (Reg[<Rs1>] >> 48) + (Temp >> 48);
  TempSum4 += TempSum4 >> 16; TempSum4 &= 0xFFFF;
  Reg[<Rd>] = TempSum1 | (TempSum2 << 16) |
  (TempSum3 << 32) | (TempSum4 << 48);
```

SRADDWC.H is a specialized sub-register instruction to allow an incremental checksum update of a standard 16-bit checksum in place. The mode for SRADDWC.H is s_s_s0_from_op1, so the second input operand is the subreg[0] variant of Rs2; this facilitates the common case where a 16-bit checksum field is updated with a “checksum delta” (for instance, as part of Network Address Translation or NAT). Pos is the sub-register position of the half-word.

Pseudo code for SRADDWC.H (Mode: s_s_s0_from_op1):
Temp1 = ExtractSubReg(Reg[<Rs1>], 2, Pos);
Temp2 = ExtractSubReg(Reg[<Rs2>], 2, 0);
TempSum = Temp1 + Temp2;
TempSum += TempSum >> 16;
TempSum = TempSum & 0xFFFF;
Reg[<Rd>] = SetSubReg(TempSum, Reg[<Rs1>], 2, Pos);

In assembly these are written csumadd.b/csumadd.h/csumadd.w/csumadd <dst>,<rs1>,<rs2>[<pos>] and addwc.h<dst>[<pos>],<rs1>[<pos>],<rs2>[0]. For SRADDWC.H, <pos> must be the same for <dst> and <rs1>, and the sub-register position for <rs2> must be zero.

### Checksum Fold Instructions

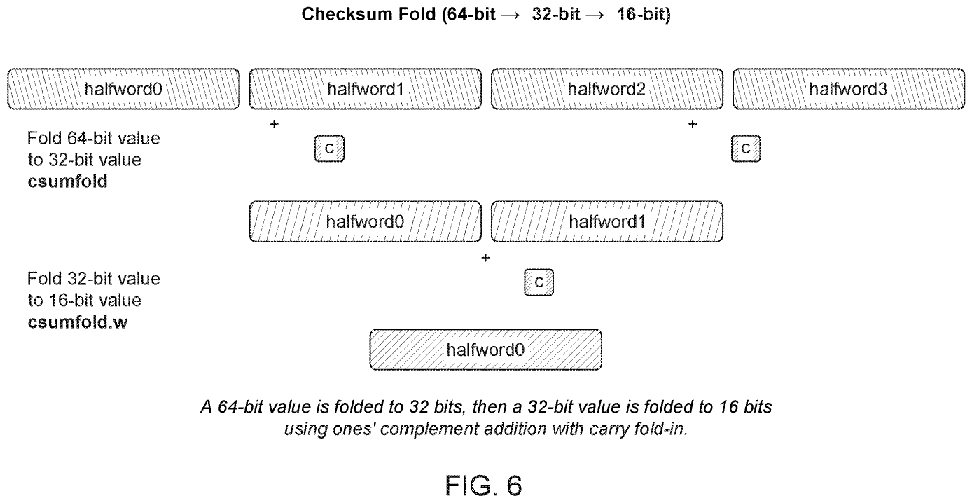

SRCSUMFOLD performs a “checksum fold” of a 64-bit value to a 32-bit value, or of a 32-bit value to a 16-bit value. The result of the fold produces a value that is mathematically equivalent to the input with regard to the properties of the standard 16-bit Internet checksum. The algorithm performs a “checksum add” of the low order word with the high order word in the case that the input is sixty-four bits, or a “checksum add” of the high order half word with the low order half word in the case that the input is thirty-two bits. In the case of a 64-bit input, the lower order thirty-two bits are “checksum added” to the high order thirty-two bits and the resulting 32-bit value is returned; in the case of a 32-bit input, the low order 16 bits are “checksum added” to the high order 16 bits and the resulting 16-bit value is returned. If the N bit is set for SRCSUMFOLD.W then the bitwise NOT of the sum is returned. The checksum fold instructions do not have a sub-register mode. FIG. 6 illustrates a checksum fold of a sixty-four-bit value to a sixteen-bit value.

In a method embodiment, a processor pipeline decodes an add-with-carry instruction specifying a first operand and a second operand, wherein at least one of the operands is a sub-register comprising a contiguous range of bits isolated within a full register, and executes a ones' complement addition on the first operand and the second operand by adding the values of the operands, detecting when an arithmetic carry-out is generated relative to a bit length of the sub-register, and, upon detecting the carry-out, adding a value of one back into a lowest-order bit of the sub-register, with the resulting ones' complement sum being stored in a designated destination operand. The SRADDWC.H instruction and the SRCSUMADD instructions described herein are examples of such add-with-carry and Internet checksum add operations, and the SRCSUMFOLD instructions described herein are examples of the checksum fold operation, in which an input register having an even bit length is logically split into an upper sub-register containing high-order bits and a lower sub-register containing low-order bits, the upper and lower sub-registers are summed using ones' complement addition, and a folded sum occupying half the bit length of the input register is written to a destination register. In an Internet checksum add, the first and second operands are of identical size and each comprise a plurality of independent sub-words, and the ones' complement addition is performed concurrently on each corresponding pair of sub-words, with each independent sum placed into a destination register at an offset matching its respective input sub-words.

Pseudo code for SRCSUMFOLD.W (Mode: r_r_r):
// Fold a thirty-two bit checksum value to sixteen bits
Temp1 = ExtractSubReg(Reg[<Rs>], 2, 0);
Temp2 = ExtractSubReg(Reg[<Rs>], 2, 1);
TempSum = Temp1 + Temp2;
TempSum += TempSum >> 16;
TempSum = TempSum & 0xFFFF;
if (N)
TempSum = ~TempSum & 0xFFFF;
Reg[<Rd>] = TempSum;
Pseudo code for SRCSUMFOLD.D (Mode: r_r_r):
// Fold a sixty-four bit checksum value to thirty-two bits
Temp1 = ExtractSubReg(Reg[<Rs>], 3, 0);
Temp2 = ExtractSubReg(Reg[<Rs>], 3, 1);
TempSum1 = (Temp1 & 0xFFFF) + (Temp2 & 0xFFFF);
TempSum1 += TempSum1 >> 16; TempSum1 &= 0xFFFF;
TempSum2 = (Temp1 >> 16) + (Temp2 >> 16);
TempSum2 += TempSum2 >> 16; TempSum2 &= 0xFFFF;
Reg[<Rd>] = TempSum1 | (TempSum2 << 16);

In assembly these are written csumfold.w<dst>,<rs> (N=0), csumfold.w.not <dst>,<rs> (N=1), and csumfold <dst>,<rs>, where <rs> is an integer register and <dst> is an integer register (not zero).

### Bit Field Manipulation

The sub-register instructions are particularly adept at manipulating bit fields, which are a common C/C++ data structure, especially in networking where protocol headers are often specified as structures containing bit fields. A bit field is a data structure that consists of one or more adjacent bits which have been allocated to hold a sequence of bits, stored so that any bit or group of bits can be inspected.

Consider the example C data structure below:
struct bit_field_example {
_{——}u64 hw: 16; // Bit position 0, aligned half-word (srpos = 0)
_{——}u64 val3: 3; // Bit position 16, odd length
_{——}u64 bit1: 1; // Bit position 19, odd length
_{——}u64 nibb: 4; // Bit position 20, aligned nibble (srpos = 4)
_{——}u64 byte: 8; // Bit position 24, aligned byte (srpos = 3)
_{——}u64 data: 12; // Bit position 32, odd length
_{——}u64 byte2: 8; // Bit position 44, unaligned byte
_{——}u64 nibb2: 4; // Bit position 52, aligned nibble (srpos = 12)
_{——}u64 byte3: 8; // Bit position 56, aligned byte (srpos = 7)
};
struct bit_field_example s;
_{——}u64 a;

This structure defines a sixty-four-bit data structure composed of nine bit fields of various sizes. For the purposes of this example, there is a variable s with the type of the structure, and a sixty-four-bit unsigned variable a. The examples below assume that s is in the a0 register and a is in the a1 register.

Examples using sub-registers to set bit fields:
// s.hw = a; (16-bit aligned field from a variable)
set.h a0[0],a0[0],a1
// s.val3 = a; (3-bit field from a variable)
masknand a0,a0,16:3
maskshift a1,a1,16:3
or a0,a1,a0
// s.val3 = 22; (3-bit field from an immediate)
masknand a0,a0,16:3
maskshifti a1,22,16:3
or a0,a1,a0
// s.byte3 += 75; (add immediate to aligned byte field
add.b a0[7],a0[7],75
Examples using sub-registers to read bit fields into a register:
// a = s.hw; (16-bit aligned field; alias for extract a1,a0,0:16)
extract.h a1,a0[0]
// a = s.val3; (3-bit field)
extract a1,a0,16:3
// a = s.byte; (8-bit aligned byte; alias for extract a1,a0,24:8)
extract.b a1,a0[3]
// a = s.byte2; (8-bit unaligned byte)
extract.b a1,a0,44:8
Sub-Registers in Parser Instructions

Sub-registers allow referencing byte, nibble, half-word, and word components of a register explicitly in instructions, and several parser instructions use sub-registers. As with the integer sub-register instructions, there are two parameters to describe a sub-register: size and position, which are expressed in the assembly for an instruction and set the Sz and Pos fields in the instruction code. In a parser instruction mnemonic, size is indicated by [nbhw] and position is indicated by <reg>[<pos>]. For example, the mnemonic format for the prs.lenset instruction is prs.lenset.[nbhw]{.stp} pourhdr,paccum{[<pos>]}, and an example use is prs.lenset.b pcurhdr,paccum[6], which computes the length of the current header based on byte number six in the Accum register. If {[<pos>]} is in the mnemonic format and [<pos>] is not present in an instruction, then the sub-register position is taken to be zero; for instance, prs.lenset.b pourhdr,paccum is equivalent to prs.lenset.b pcurhdr,paccum[0]. The Sz field encodings and the number of bits in the sub-register value are the same as described above for integer sub-register instructions, including the alternate meaning of Sz equal to 0 for parser load and store instructions.

### Content-Addressable Memories and CAM Instructions

A content-addressable memory (CAM) is a type of memory used for very fast key-value lookups. It can be organized as a table of key-value pairs. When a key is input into the engine, all of the keys are compared in parallel, and if there is a match the associated value is returned. To do this, each memory bit of each key entry, called a cell, has its own comparison circuit. Additionally, match outputs from each cell are combined to yield a match signal for each entry, and those signals are considered to find the matching entry. A CAM is expensive because of the comparison logic and the logic for combining output signals, and the total cost of the CAM is a function of the number of bits in the key and the number of entries.

### CAMs and Switch Statements

A CAM may be used to efficiently implement a switch statement in a programming language such as C. As an example, consider a switch statement on EtherType that might be used when parsing an Ethernet header, with cases for IPV4 (0x800) and IPV6 (0x86DD) and a default case for an unknown protocol. The switch statement is elegant in syntax, but compiling it into processor instructions is not straightforward. In the worst case, the compiler builds a binary search tree of cases and searching the tree is O (log 2 (N)) where N is the number of cases. If all case values are small integers, a jump table might be employed; for instance, if all cases are greater than or equal to zero and less than sixteen, the compiler may test the value and index a sixteen-element array of addresses. The downside to jump tables is that they do not scale well as case values get large; for instance, the EtherType lookup could require allocating a 65,536-element array, which is prohibitive. Other techniques use combinations of hashes, Hamming codes, and jump tables, but no software method approaches the efficiency that a CAM provides, which can be as simple as goto CAM_LOOKUP(v), where CAM_LOOKUP is a hardware function that returns either an address for a matched key or a default address if no key is matched, and is an O (1) operation.

### CAM Design

CAMs are useful for very fast lookups on protocol numbers in a programmable parser, such as the EtherType lookup described above. With a particular use case in mind, the CAM design can be tailored exactly to the problem to elicit an elegant and cost-effective solution. In one design, each CAM entry has a 20-bit key and a 32-bit target. The target may be an encoded address, a parser error code, or have some other interpretation based on the context of the lookup. There is only one CAM in the system, so the key is encoded with a selector to allow multiple sub-tables. The number of entries is configurable as a power of two; for example, designs with thirty-two or sixty-four entries.

### CAM Keys

A CAM key is structured in one of two ways as indicated by the four high order bits of the key, called the Kind field. The key may be expressed as a union of two structures, as shown below.

union {
struct {
Kind: 4; // Set to non-zero, global selector
MatchVal16: 16; // Sixteen bit match value
} Match16;
struct {
Kind: 4; // Set to zero
Selector: 8; // Single use selector
MatchVal8: 8; // Eight bit match value
} Match8;
}

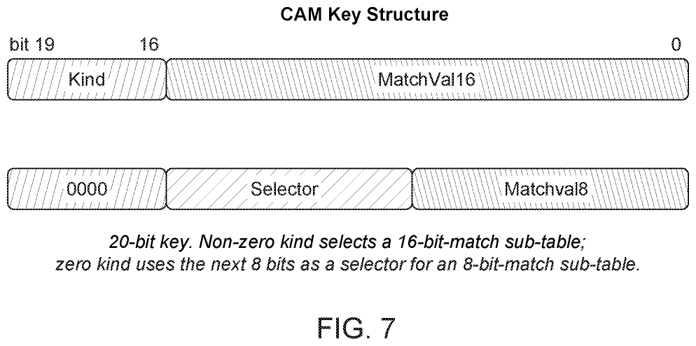

If Kind equals zero, then the Match8 structure is used: Selector selects one of 256 sub-tables, with an 8-bit value to match in Match Val8. If Kind is non-zero, then the Match 16 structure is used: Kind selects one of fifteen sub-tables (numbered 1 to 15), with a 16-bit value to match in MatchVal16. This arrangement allows matching either 16-bit values (like EtherType) using Match16 or 8-bit values (like an IP protocol number) using Match8. FIG. 7 illustrates the CAM key structure.

### Programming the CAM

The CAM is nominally part of the parser, and it is invoked and programmed by parser instructions. The CAM is programmed by writing entries in the CAM table. CAM entries are written using a prs.cam.write instruction, where the first source operand is a table index and the second operand encodes the key and the target value; the key occupies the high order thirty-two bits of the second operand, and the target occupies the low order thirty-two bits. A CAM entry is removed by writing a key value of 0xFFFFFF, which is an invalid key value. A CAM entry can be read using a prs.cam.read instruction. Example instructions are prs.cam.write a0, paccum and prs.cam.read a5, paccum.

### Instructions for CAM Lookups

CAM lookup instructions specify the CAM sub-table in a four-bit immediate (which refers to the Kind field in the key structure). Values one through fifteen refer to the Match16 sub-tables; these are shared tables since they can be referred to by multiple instructions. If the immediate is zero, this refers to a Match8 table, which is a non-shared table, and the Selector is derived from the low order bits of the program counter (PC) for the instruction by Selector=(PC>>6) & 0xFF.

In an apparatus embodiment, a computing system comprises a content-addressable memory (CAM) block configured to store a unified lookup table comprising a plurality of virtual sub-tables, a processor coupled to the CAM block and configured to execute a CAM lookup instruction specifying a match operand and a selector operand, and a hardware lookup controller. The virtual sub-tables are the sub-tables described herein that are located within the single CAM table by the selector encoded in the key, and the match operand and selector operand correspond, respectively, to the match value and the selector described herein. The hardware lookup controller responds to execution of the CAM lookup instruction by prepending the selector operand to the match operand to form a composite lookup key, querying the CAM block using the composite lookup key to locate a matching entry, and, upon a match, retrieving a target value from the matching entry and writing the target value to an output register.

The selector operand may be a single-use selector value derived dynamically from an instruction pointer address of the CAM lookup instruction being executed, for example by the relation Selector=(PC>>6) & 0xFF described above, thereby isolating the virtual sub-table to that specific CAM lookup instruction; the program counter and the instruction pointer address refer to the address of the executing instruction. The hardware lookup controller is further configured to detect a CAM lookup miss when the composite lookup key matches no entries in the CAM block, and, in response to the miss, to automatically redirect processor execution to a pre-configured hardware error handler address, such as the wildcard handler described herein, or to write a default fallback value to the output register.

A compiler may optimize a programming language conditional branch statement, such as a switch statement, by allocating a specific virtual sub-table within the CAM block for the conditional branch statement, populating the specific virtual sub-table with entries in which each case value of the conditional branch statement is a match operand and each corresponding branch target address is a target value, and emitting a CAM lookup instruction using a selector operand mapped to the specific virtual sub-table, as described above in connection with the use of CAMs to implement switch statements.

There are different variants of parser instructions for CAM lookup. Common operands include:

The Match Val part of the key from a parser register (8 or 16 bit values).

A table selector immediate value expressed as a number between 1 and 15 for shared tables, or pc for a non-shared table.

A “miss” directive that indicates the action to take on a CAM miss, indicated by a suffix on the mnemonic: no suffix to continue, wild to jump to a handler in a WildCard register, .stop to exit the parser with success, .stopsub to stop the current sub-node or loop iteration with success, and .fail to exit the parser with failure.

Some examples of lookup instructions are:
prs.cam.h paccum,paccum[2], 10
//Lookup an EtherType in the third word of the accumulator
//register and return the target in the accumulator; on a
//miss, proceed to the next instruction.
prs.cam.b.wild.stp pnext,pflags[3],pc
//Lookup an IP protocol in the fourth byte of the flag
//register and set the target in the Next register; on a
//miss, jump to the wildcard handler.
prs.camjumptlvloop.b.stopsub.stp paccum,pc
Lookup a TCP option for the first byte in the accumulator
register and jump to the target node in the context of a
TLV loop; on a miss, exit the TLV loop with success.

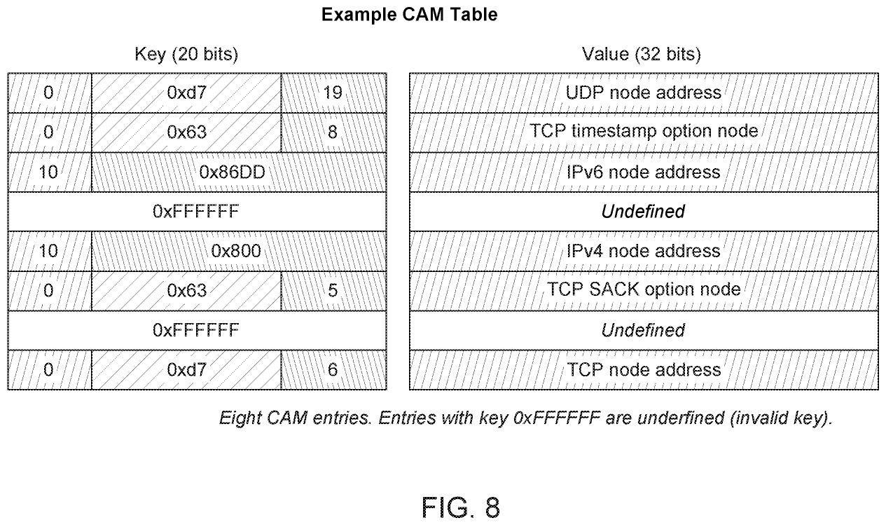

FIG. 8 illustrates an example CAM table having eight entries. A non-shared sub-table performs a sixteen-bit lookup on EtherType, a shared table (selector 0xd7) performs a lookup on an IP protocol number, and a shared table performs a lookup on a TCP option number. Entries with a key value of 0xFFFFFF are undefined. For a non-shared table, the selector value is set to match the value derived from the address of the lookup instruction by (PC>>6) & 0xFF.

### Sub-Register Operational Pipeline Architecture

In a further apparatus embodiment, the processing pipeline contains specialized hardware logic configurations capable of executing arithmetic, logical, and comparative operations directly on dynamically defined bit subsets within the register file. By providing direct sub-register access paths within the execution framework, the architecture eliminates the serial mask-and-shift instruction overhead that standard processor architectures require to manipulate densely packed data structures such as bit fields within a networking protocol header or an application layer record. The instruction decoder is structurally coupled to an instruction register and configured to process sub-register instruction opcodes. Unlike conventional Single Instruction Multiple Data (SIMD) or vector architectures that subdivide wide registers into static, uniform, pre-allocated power-of-two data lanes, the present architecture processes an operand defining an arbitrary, variable, and contiguous subset of bits within any designated register file location, wherein the subset of bits defines an arbitrary bit boundary that is independent of fixed, uniform power-of-two data lane subdivisions within the designated register.

The instruction decoder identifies the structural boundaries of the target sub-register via parameters encoded directly within the instruction opcode, or retrieved dynamically from an auxiliary index register during the instruction dispatch cycle, the structural parameters including a starting bit offset (BitPos) and a bit length metric (BitLength). During an execution cycle, the execution unit receives the decoded parameters and engages hardware extraction networks to isolate the specified subset of bits from the input register, using an internal pipeline routing topology that right-shifts the contents of the designated register by the specified bit offset to align the sub-register with the low-order processing bit lanes of an internal execution register, and applies a dynamically generated bitmask corresponding to the bit length metric to filter out adjacent, unselected data fields, consistent with the ExtractSubReg operation described herein.

Prior to routing the extracted value into the primary arithmetic logic unit (ALU) core, the pipeline conditionally passes the data through sign-modification circuits within an internal pipeline of the execution unit. If the instruction decoder flags a signed sub-register operation, the sign-modification circuits evaluate the high-order bit position of the isolated sub-register, and if this sign bit is asserted, the circuit executes a sign-extension sequence that populates the remaining high-order bits of the internal execution register with ones to preserve the signed mathematical integrity of the variable within the wide execution datapath. The decoded instruction may be a comparative operation that tests a logical relationship between the value of the sub-register and a second data value, wherein execution of the comparative operation alters conditional processor state execution logic, for example by setting processor flags or causing a branch in a branch-and-compare instruction.

Following execution of the primary arithmetic or logical operation, the generated result is committed back to a designated destination. Where the destination target is itself a sub-register confined within a wide destination register, the execution unit activates dedicated insertion logic networks that execute a destructive overwrite strictly bounded by the target sub-register bit offset and length, leaving all adjacent, unselected bits of the destination register unmodified. To accomplish this single-cycle write-back, the insertion logic masks the low-order bits of the generated ALU result to match the bit length of the target sub-register, left-shifts the masked result by the destination bit offset, zeroes out the targeted bit zone within a copy of the destination register contents using a complement bitmask, and merges the left-shifted result with the zeroed destination register copy using a hardware bitwise OR gate, consistent with the SetSubReg operation described herein.

To maximize execution throughput and minimize critical timing path latencies, the processor core integrates a zero-overhead pipeline forwarding network containing comparator circuits that monitor the source and destination register indices of instructions migrating through successive pipeline stages. When a subsequent instruction requires the contents of a target sub-register before those bits have been committed back to the physical register file, the forwarding network intercepts the intermediate result directly from the output of the execution unit and routes the intercepted data over dedicated bypass lines into the input stage of the subsequent execution cycle, preventing pipeline stalls.

To optimize the thermal and power dissipation profiles of the silicon fabric, the execution unit integrates circuit-level power-management logic that evaluates the decoded bit length parameters of the active instruction to identify which portions of the full register width are unselected for the current operation. During the execution phase, the power-management logic generates localized clock-gating signals that restrict clock signals to, and temporarily deactivate the clock trees feeding, the arithmetic logic circuits, flip-flops, and bus drivers corresponding to the unselected bit lanes, reducing dynamic power consumption during sub-register execution.

Ones' Complement Checksum Hardware Acceleration Engine

In a further embodiment, native ones' complement arithmetic execution blocks are embedded into the arithmetic execution path to accelerate packet verification and Internet protocol throughput, bypassing standard two's complement sign-extension logic to directly compute network validation structures such as the standard 16-bit Internet checksum within the primary execution pipeline. The arithmetic logic unit includes carry-out detection circuits configured to monitor the highest-order bit boundary of the operational bit length specified by the instruction. When executing a ones' complement addition, the engine adds the values of the two input operands to produce an intermediate sum, and if the carry-out detection circuit asserts a signal indicating that an arithmetic carry-out has escaped the operational bit boundary, an end-around carry loop is triggered that routes the carry-out bit back into the lowest-order bit lane of the adder circuit, incrementing the destination sum by a value of one within the same or a subsequent clock cycle.

For parallel packet parsing workloads, the checksum acceleration engine organizes these computation blocks into a multi-lane parallel execution field. When an instruction specifies a parallel checksum addition, a wide register boundary is logically segmented into a plurality of distinct, independent sub-register fields or sub-words, and the hardware engine replicates the ones' complement adder and carry-out detection circuits in parallel across each field boundary such that the pairs of distinct sub-register fields are summed simultaneously and independently, each lane processing its own localized end-around carry fold, with the parallel results concurrently bitwise ORed into their respective matched offsets within the destination register footprint to execute a vector-style checksum calculation.

The engine further integrates a register-splitting fold module. When a checksum fold instruction is decoded, the module accepts a wide input register containing an intermediate checksum record and logically bisects it along its median bit boundary into an upper sub-register holding high-order bits and a lower sub-register holding low-order bits, feeds these two halves into a ones' complement adder cell that folds the upper half into the lower half and resolves any generated end-around carry, and produces a folded sum that compresses the bit width of the record by half, bringing it into conformity with standard network protocol field lengths.

The checksum acceleration engine further includes dedicated exception tracking logic linked to a processor control register. The exception logic monitors the final output of the ones' complement addition circuits to detect a predetermined bit-saturation condition, specifically where the operational bit length of the sum contains entirely ones, representing negative zero in ones' complement notation. Upon detecting this saturation state, the exception tracking logic sets a dedicated checksum status flag within the control register, informing downstream protocol parsers that a valid zero-checksum condition has been achieved and eliminating the need for subsequent conditional branch instructions to evaluate the sum.

### Programmatic Contextual Content-Addressable Memory Lookups

In a further apparatus embodiment, a hardware lookup controller linked directly to the processor pipeline manages the content-addressable memory (CAM) block to provide constant-time O (1) key-value evaluations for high-speed programmatic routing and branch acceleration, such as the execution of compiler-generated switch statements or protocol parsing engines. The CAM block is structured as a single, unified physical lookup table configured to operate as a multi-tenant lookup space containing a plurality of virtual sub-tables. To achieve logical isolation between these virtual sub-tables without physically segregating the underlying memory cells, the hardware lookup controller enforces a composite lookup key topology, wherein the processor passes a search value, being a match operand, and a contextual selector operand to the controller, and a hardware combining circuit prepends the contextual selector operand to the high-order bits of the search value to generate a unified composite key.

In a preferred embodiment, the composite key length is bounded to 20 bits and is decoded via a hardware union interface governed by a multi-mode configuration block that monitors the highest-order bits of the incoming composite key, designated as a table Kind field. If the Kind field contains a non-zero value, a wide global lookup mode is enabled and the controller treats the lower bits as a 16-bit match value to be evaluated across one of fifteen shared global virtual sub-tables. Conversely, if the Kind field evaluates to zero, a non-shared lookup mode is triggered in which the hardware lookup controller reads the current execution program counter (PC) or instruction pointer address of the specific CAM lookup instruction being executed and routes this instruction address through a hardware bitwise transform circuit to derive a single-use selector value according to the relation Selector=(PC>>6) & 0xFF, the address-derived selector being combined with an 8-bit search value to complete the composite key and thereby locking the virtual sub-table search space to that specific programmatic command.

The CAM block further incorporates local ternary masking logic arrays paired with each entry. When a query is initiated, the hardware lookup controller can selectively apply a local bitmask to the search value component of the composite key, instructing the comparison logic gates within the CAM cells to disregard a designated subset of bits during the evaluation cycle, such that a single entry within a virtual sub-table can be configured to satisfy an arbitrary range of incoming values and thereby optimize storage efficiency when handling sparse or bounded conditional structures.

A compiler may employ an optimization module that maps a programming language conditional branch statement into the lookup table by compiling case criteria into corresponding search values and branch destination addresses into corresponding target values, and substituting the conditional branch statement with the CAM lookup instruction. To mitigate performance penalties associated with table capacity limits, the system features a hardware pre-fetching state unit containing predictive tracking circuits that monitor the sequence and flow of instructions executing through the processor pipeline; by analyzing the historical progression of contextual selectors and instruction pointer paths, the tracking unit predicts an upcoming activation of a specific virtual sub-table region and, before the pipeline dispatches the subsequent CAM lookup instruction, initiates a proactive direct memory access sequence that stages the required entries from an external memory space into a low-latency local cache buffer embedded within the hardware lookup controller.

If an executed query against the CAM block fails to achieve a match across the active table array, an unmapped lookup condition or CAM miss is declared, and the hardware lookup controller evaluates a dedicated miss directive suffix encoded within the instruction opcode. Depending on the decoded suffix, the controller executes a hardware-level recovery loop that includes writing a pre-configured default fallback value to the processor destination register, halting the active parser loop iteration with a success flag, or executing an immediate hardware redirection of the program counter to a pre-configured error handler address.

### Automated Sub-Register Endian Realignment and CAM Capacity Virtualization.

The system is designed to handle arbitrary, variable bit boundaries dynamically inside the hardware pipeline within a single clock cycle, eliminating the multi-instruction shift/mask/setup overhead found in conventional architectures. Because sub-register operands, variable bit boundary parameters, serialized data lane subdivisions, and composite search keys frequently arrive at or are loaded into the register file from communication links or external multi-die planes utilizing a network-ordered big-endian serialization format, manipulating these definitions within a host domain's native little-endian processing core can introduce software-level shift, mask, and swap instruction overhead.

In a further embodiment, the system routes incoming operands and execution streams through an inline hardware swizzle matrix containing a parallel array of crossbar byte-multiplexer gates structurally integrated inline with the core execution path. This combinatorial matrix intercepts raw register blocks and sub-word definitions on-the-fly and mirrors their byte configurations into a host-aligned little-endian layout within a single processor clock cycle, allowing the instruction decoder to parse bit lengths and the execution unit to execute operations on the target sub-register without modifying adjacent bits or introducing microarchitectural wait-states. This inline byte-swizzle operation is consistent with, and may employ, the ByteSwap operation described herein.

Concurrently, the CAM block, context controllers, and co-resident lookup table structures are protected against hardware traps and state registry saturation via an integrated virtual CAM overflow spillover cache. The controller relies on an internal capacity validation registry or localized tracking matrix to map active composite keys, trace contextual selectors, and monitor branch destination addresses across the memory space. In the event of a workload surge, cascading conditional branch evaluations, or a multi-tenant lookup instruction burst that triggers an entries capacity validation fault within the internal capacity validation registry, an inline hardware extraction engine automatically intercepts the unmapped composite keys and, rather than forcing a hardware exception trap that flushes the execution pipeline, diverts the unmapped parameters into an asynchronous virtual CAM spillover cache allocated within an auxiliary static random-access memory (SRAM) layer.

This elastic buffer isolates the capacity boundary, enabling the controller to continue querying lookup fields, verifying mask logic, and returning target values to designated processor destinations across active, valid contexts to maintain non-blocking target value resolution. While the processor maintains continuous, non-blocking stream execution, an autonomous hardware-driven background eviction circuit sweeps the primary CAM registry to clear stale or retired lookup patterns, systematically migrating the virtual cache allocation profiles back to physical hardware slots as the resource surge subsides.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

What is claimed is:

1. A processor architecture comprising: a register file containing a plurality of registers; an instruction decoder configured to decode an instruction specifying an operation and at least one operand, wherein the operand defines a sub-register comprising a subset of bits within a designated register of the register file, the subset of bits being identified by a size parameter and a position parameter associated with the instruction; and an execution unit configured to execute the decoded instruction by isolating a value of the sub-register from the designated register based on the size parameter and the position parameter, performing the operation using the value to generate a result, and writing the result to a destination.

2. The processor architecture of claim 1, wherein the size parameter and the position parameter are encoded as a size field and a position field within an instruction opcode bit field of the instruction, or are retrieved dynamically from an index register specified by the instruction during execution.

3. The processor architecture of claim 1, wherein the designated register is addressable as a hierarchy of independently addressable sub-register slices, wherein the hierarchy comprises a plurality of distinct structural data layouts defined as a 4-bit nibble slice, an 8-bit byte slice, a 16-bit half-word slice, and a 32-bit word slice, and wherein the size parameter selects among the nibble, byte, half-word, and word slices to isolate a contiguous subset of bits.

4. The processor architecture of claim 1, wherein the subset of bits defines an arbitrary, contiguous bit field identified by a bit position parameter and a bit length parameter, independent of fixed, uniform power-of-two data lane subdivisions within the designated register.

5. The processor architecture of claim 1, wherein the destination is a target sub-register within a target register, and wherein the execution unit overwrites only bits within the target sub-register while leaving all other bits of the target register unmodified, thereby permitting partial sub-word updates without corrupting adjacent sub-register states within the target register.

6. The processor architecture of claim 1, wherein the execution unit isolates the value of the sub-register by right-shifting contents of the designated register by a bit offset of the sub-register to create an intermediate value, and masking low-order bits of the intermediate value with a bitmask corresponding to a length of the sub-register, without modifying the designated register.

7. The processor architecture of claim 1, wherein the execution unit includes a selectable masking network comprising: a sign-extension mask configured to evaluate a signedness indicator associated with the instruction and, when a high-order sign bit of the sub-register is asserted, replicate the sign bit across remaining upper-order bits of an internal execution register to preserve two's-complement arithmetic correctness; and a zero-padding mask configured to set the remaining upper-order bits of the destination to zero.

8. The processor architecture of claim 1, wherein the decoded instruction is a comparative operation that tests a logical relationship between the value of the sub-register and a second data value, and wherein execution of the comparative operation alters conditional processor state execution logic by setting a processor flag or branching execution to a target instruction address.

9. The processor architecture of claim 1, further comprising a pipeline forwarding bypass network structurally wired between an output of the execution unit and an input stage of a subsequent execution cycle, the pipeline forwarding bypass network configured to detect when a subsequent instruction requires the result before the result is committed to the register file and, in response, to route the result directly over dedicated bypass lines into the input stage of the subsequent execution cycle, bypassing a register file write-back path to prevent data dependency pipeline stalls.

10. The processor architecture of claim 9, wherein the pipeline forwarding bypass network is governed by comparator circuits configured to monitor source and destination register indices of instructions migrating through successive pipeline stages to detect a matching sub-register data dependency.

11. The processor architecture of claim 1, wherein the execution unit contains power-management logic configured to identify unselected bit sections of the designated register based on decoded bit length parameters of the instruction and to restrict clock signals to arithmetic logic circuits corresponding to the unselected bit sections during execution.

12. The processor architecture of claim 1, further comprising an inline hardware swizzle matrix containing a parallel array of crossbar byte-multiplexer gates structurally integrated inline with the instruction decoder and the execution unit, wherein when an operand defining the sub-register is formatted in a network-ordered big-endian serialization profile, the inline hardware swizzle matrix dynamically mirrors byte boundaries of the operand into a host-aligned little-endian layout within a single processor clock cycle prior to the execution unit generating the result.

13. The processor architecture of claim 1, wherein the instruction decoder is further configured to process byte-swap primitives including a swap-and-set primitive that reverses an endianness of a source value and sets the reversed value into a target sub-register of a target register, and an extract-and-swap primitive that isolates the value of the sub-register and reverses the endianness of the isolated value prior to writing the result to the destination.

14. A processor architecture comprising: an execution unit, wherein the execution unit comprises a native ones' complement arithmetic block including carry-out detection circuits, the ones' complement arithmetic block configured to execute a ones' complement addition on a first operand and a second operand, and, upon the carry-out detection circuits asserting that an arithmetic carry-out has escaped an operational bit boundary of the addition, to trigger an end-around carry loop that routes a carry-out back into a lowest-order bit lane of the addition to increment a resulting sum by a value of one.

15. The processor architecture of claim 14, wherein the first operand and the second operand are of identical size and each comprise a plurality of independent sub-words, and wherein the ones' complement addition is executed concurrently on each corresponding pair of sub-words to compute a vector ones' complement sum operation, each independent sum being placed into a destination register at an offset matching its respective input sub-words.

16. The processor architecture of claim 14, wherein an instruction decoder processes a checksum fold primitive that logically splits an input register having an even bit length into an upper sub-register containing high-order bits and a lower sub-register containing low-order bits, sums the upper sub-register and the lower sub-register using a ones' complement addition, and writes a folded sum occupying half the bit length of the input register to a destination register to execute a ones' complement compression operation.

17. A processor architecture comprising: a content-addressable memory (CAM) block configured to store a unified lookup table comprising a plurality of virtual sub-tables; and a hardware lookup controller configured to respond to execution of a lookup instruction defining a search value and a contextual selector by combining the contextual selector with the search value to generate a composite key, querying the CAM block using the composite key to identify a matching table entry, and returning a target value associated with the matching table entry to a processor destination.

18. The processor architecture of claim 17, wherein the contextual selector is derived dynamically from an execution address of the lookup instruction, thereby isolating a search space of the unified lookup table to a virtual sub-table associated with that specific lookup instruction.

19. The processor architecture of claim 17, wherein the hardware lookup controller is configured to detect an unmapped lookup condition when the composite key matches no entries within the CAM block, and, in response, to automatically redirect processor execution to a pre-configured error handler address or write a default fallback value to the processor destination.

20. The processor architecture of claim 17, wherein the CAM block tracks active composite keys and contextual selectors via an internal capacity validation registry, wherein upon detection of a capacity validation fault within the internal capacity validation registry, an inline hardware extraction engine automatically intercepts unmapped composite keys and diverts the unmapped composite keys into an asynchronous virtual CAM spillover cache allocated within an auxiliary local hardware memory layer to maintain non-blocking target value resolution, and wherein an autonomous background eviction circuit clears stale lookup patterns from the CAM block and migrates spillover allocations back to physical hardware slots as a resource surge subsides.
